(19) United States
(12) Patent Application Publication
(10) Pub. No.: US 2011/0108144 A1
(43) Pub. Date: May 12, 2011

(54) MULTI-PORT QUICK CONNECT FLUID TREATMENT TANK HEAD

(75) Inventors: John TADLOCK, West Chicago, IL (US); Michael Baird, Temecula, CA (US); Thomas Wilcox, Waterford, WI (US)

(73) Assignee: Anova Resources LLC, Wausau, WI (US)

(21) Appl. No.: 12/614,838

(22) Filed: Nov. 9, 2009

(51) Int. Cl. F15D 1/02

(52) U.S. Cl. 137/597

(57) ABSTRACT

A tank head including a plurality of input ports, a plurality of output ports, and a connection fitting is provided. The plurality of input ports are in direct communication with one another, the plurality of output ports are in direct communication with one another, and the connection fitting is capable of associating the tank head with a fluid tank. Ends of each one of the input and output ports within the pluralities are capable of being associated with a first end of a connection adapter.

### FIELD OF THE INVENTION

The present invention relates generally to the field of filtering systems and more particularly to a filtering system that includes multi-port tank heads for use on fluid treatment tanks.

### BACKGROUND OF THE INVENTION

Fluid treatment systems can use different types of filters for filtering different substances from the fluids processed therethrough. Furthermore, fluid treatment systems can include a plurality of filtering phases that typically require special setup and connections between the different filtering components.

One of the known problems associated with fluid treatment systems is that the filter removal and replacement process often requires a significant amount of time and manpower. The amount of time and manpower required is only magnified when the system uses different types of filters or includes a plurality of different filtering phases.

The nature of fluid treatment systems using different types of filters has historically made it difficult remove and replace the various filters. There is thus, a continuing, ongoing need for a tank head that can be used in connection with a fluid treatment system wherein the tank head incorporates multiple ports. Preferably, the various ports of the tank head can be associated with different types of filters.

### SUMMARY OF THE INVENTION

According to the present invention, a tank head is provided. The tank head can include a plurality of input ports that are in direct communication with one another, a plurality of output ports that are in direction communication with one another, and a connection fitting that is capable of associating the tank head with a fluid tank. Ends of each one of the input ports and output ports within the pluralities are capable of being associated with one end of a connection adapter.

Furthermore, a system of tank heads is provided that can include a plurality of tank heads, a plurality of connection adapters, and a plurality of fluid supply lines. Each tank head in the system can include a plurality of input ports in direct communication with one another, a plurality of output ports in direct communication with one another, and a connection fitting that is capable of associating the tank head with a tank. Ends of each one of the input ports and output ports within the pluralities are capable of being associated with first ends of connection adapters within the plurality, and second ends of the connection adapters are capable of being associated with first ends of fluid supply lines within the plurality.

Accordingly, it is a benefit of the present invention to provide a tank head that incorporates multiple input and output ports.

It is a further benefit of the present invention to provide a tank head that can use different types of filters simultaneously.

It is yet another benefit of the present invention to provide a singular tank head that can allow for multiple filtering phases.

It is still a further benefit of the present invention to provide a multi-port tank head that can be incorporated into a system of multi-port tank heads.

Finally, it is a benefit of the present invention to provide a system of multi-port tank heads that can be configured to allow for various flow patterns between the ports of the various tank heads.

In accordance with the present invention, all of these benefits as well as others not herein specifically identified are generally achieved by the present multi-port quick connect fluid treatment tank head.

### BRIEF DESCRIPTION OF THE DRAWINGS

Various examples of objects, features and attendant advantages of the present invention will become fully appreciated as the same becomes better understood when considered in conjunction with the accompanying drawings, wherein:

FIG. 1A is a top view of a tank head with an input port and output port;

FIG. 1B is a side view of a tank head with an input port and an output port;

FIG. 2 is a side view of a tank head incorporating two port connections;

FIG. 3 is a top perspective view of a multi-port tank head in accordance with the present invention;

FIG. 4 is a bottom perspective view of a multi-port tank head in accordance with the present invention;

FIG. 5 is a first side view of a tank head in accordance with the present invention;

FIG. 6 is a cross-sectional top view of the first side view of the tank head shown in FIG. 5;

FIG. 7 is an end view of a tank head in accordance with the present invention;

FIG. 8 is a cross-sectional view of the end view of the tank head shown in FIG. 7;

FIG. 9 is a top view of a system of tank heads incorporating multiple ports and connections therebetween in accordance with the present invention;

FIG. 10 is a top view of a tank head incorporating multiple ports and plugs in accordance with the present invention; and

FIG. 11 is a side view of a tank head in accordance with the present invention in association with a protective cover and a lower strainer basket.

### DETAILED DESCRIPTION OF THE INVENTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include a tank head that can be associated with a fluid treatment tank. The tank head can incorporate multiple ports, and, in preferred embodiments, the tank head can include a quick connection fitting to associate the head with a fluid treatment tank.

A tank head in accordance with the present invention can be machined or injection molded. In preferred embodiments, the tank head can be formed from a material that is inert and non-reactive to the fluid being treated in connection with the head. Such material can include, but is not limited to, plastic, chrome, stainless steel, and brass or a combination thereof.

In embodiments of the present invention, a tank head can incorporate multiple inlet and outlet ports. The ports can be configured in various ways with ports from other tank heads to create various flow patterns between and among the tanks. For example, a plurality of fluid treatment tanks can be connected in series, parallel, or a combination of series and parallel flows. In a preferred embodiment of the present invention, up flow and down flow patterns, which are preferable in flow-specific filter media, can be achieved in a system of fluid treatment tanks.

The multiple ports associated with a tank head allow for quick and easy modifications to the flow scheme between and among tanks. Additionally, unused ports can be blocked off with plugs, which can be held in place with retaining clips.

Embodiments of the present invention include a location within the tank head for gauge-type connections. Gauge-type connections are useful to determine when the tank media requires service. Additionally, a gauge-type connection can incorporate an electronic interface and initiate a flushing or back wash function.

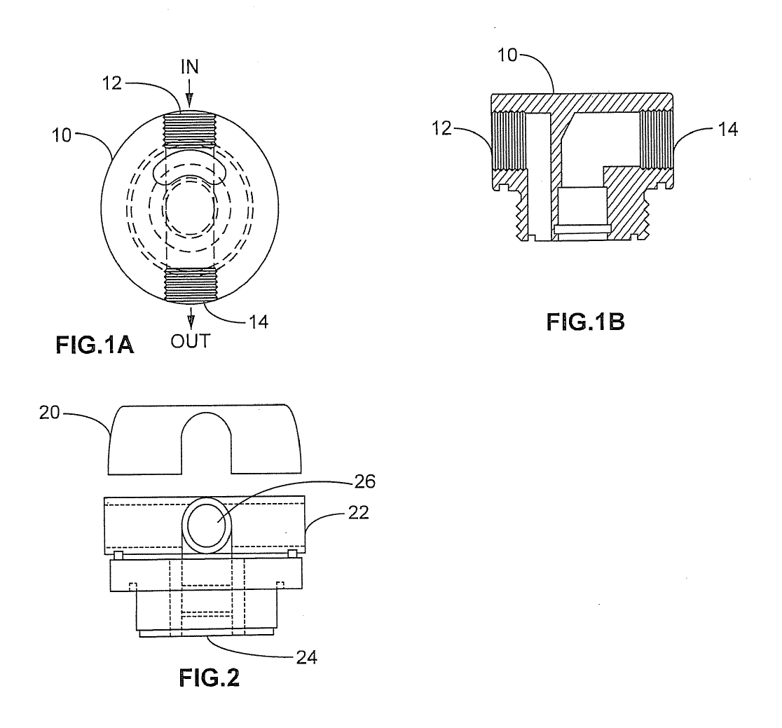

Referring now to FIG. 1A, a top view of a tank head with an input port and an output port is shown. Traditionally, a tank head 10 includes only two ports: an input port 12 and an output port 14. As can be seen in FIG. 1A, during operation, fluid enters the tank head 10 via the input port 12 and exits the tank head 10 via the output port 14. The tank head 10 can be affixed to a fluid treatment tank as would be understood by one of ordinary skill in the art.

Similarly, a side view of a tank head with an input port and an output port is shown in FIG. 1B. During operation, fluid enters the tank head 10 via the input port 12 and exits the tank head 10 via the output port 14.

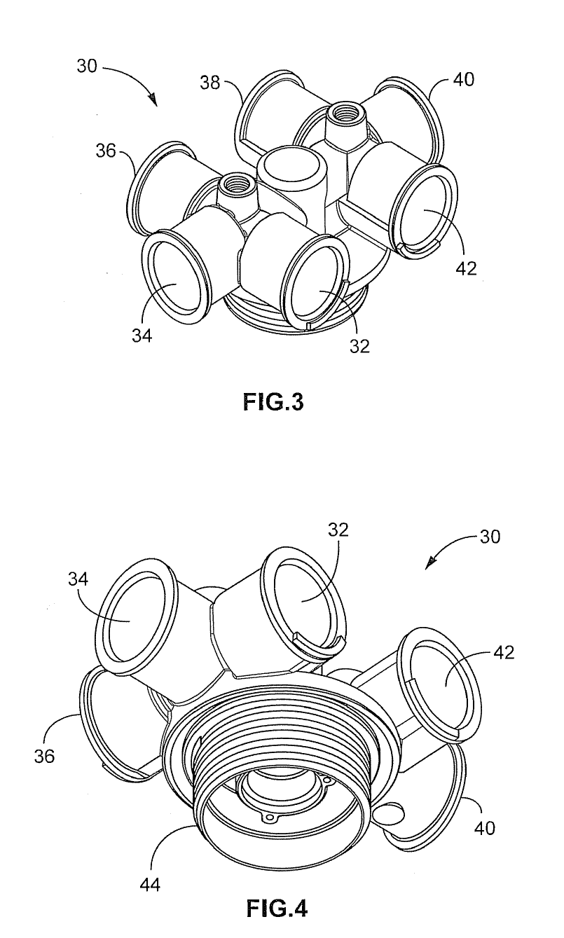

FIG. 2 is a side view of a tank head incorporating two port connections. When a tank head incorporates more than one inlet port or more than one outlet port, the inlet ports or outlet ports, respectively, can be connected with one another inside the tank head. The connections between the various ports provide for ease of installation. In embodiments of the claimed invention, the connections between the ports can be straight pipes, elbows, tees, barbs, reducers, or any other type of connection as would be understood by those of ordinary skill in the art. In the exemplary embodiment of FIG. 2, the tank head 20 incorporates ports 22 and 26, which are connected via tank connection 24.

Referring now to FIG. 3, a top perspective view of a multi-port tank head in accordance with the present invention is shown. The tank head 30 can incorporate a plurality of ports 32, 34, 36, 38, 40, and 42. It is to be understood that the number of ports incorporated into the tank head is not a limitation of the present invention. Rather, the number of ports incorporated into a tank head could be more or less than the number shown in FIG. 3.

FIG. 4 is a bottom perspective view of the multi-port tank head shown in FIG. 3. As seen in FIG. 4, the tank head 30 can include a connection fitting 44 to connect the tank head 30 to a fluid treatment tank (not shown). The connection fitting 44 can be screwed on, snapped on, or connected to the treatment tank in any other way as would be known by those of ordinary skill in the art. In embodiments of the present invention, the connection fitting 44 allows for the quick connection of the tank head 30 to a fluid treatment tank.

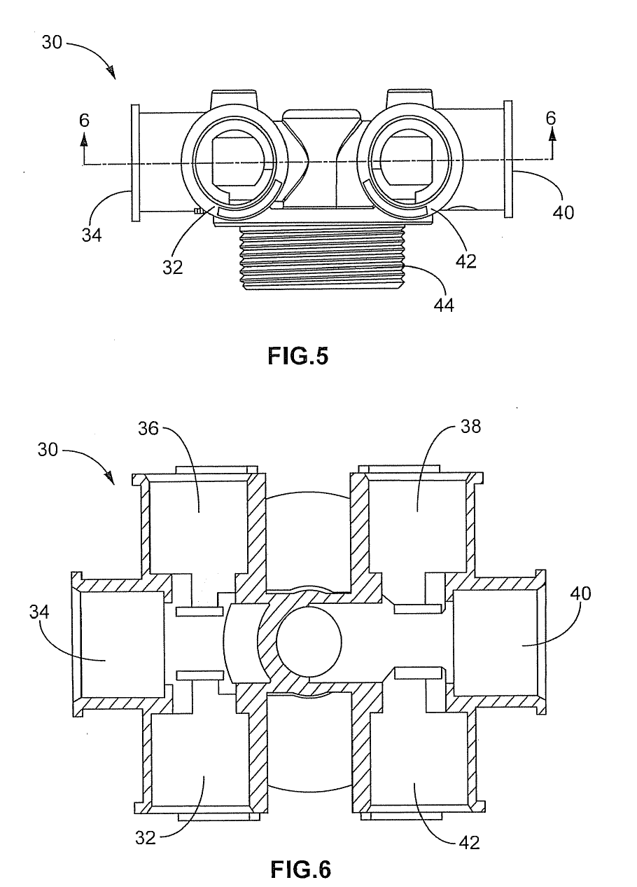

FIG. 5 is a first side view of a tank head in accordance with the present invention, and FIG. 6 is a cross-sectional top view of the first side view shown in FIG. 5. The ports 32, 34, 36, 38, 40, 42 of a tank head 30 can be in fluid communication with one another. As seen in the exemplary embodiments of FIGS. 5 and 6, ports 32, 34, and 36 are in direct communication with one another, while ports 38, 40, and 42 are in direct communication with one another. That is, one side of the tank head 30 includes a plurality of inlet ports 32, 34, 36, and one side of the tank head includes a plurality of outlet ports 38, 40, 42.

When fluid enters the inlet ports 32, 34, 36 of the tank head 30, the fluid is directed into an associated fluid treatment tank in accordance with the configured flow pattern of the tank head 30. When fluid exits the fluid treatment tank, it is directed towards the outlet ports 38, 40, 42 in accordance with the configured flow pattern of the tank head 30.

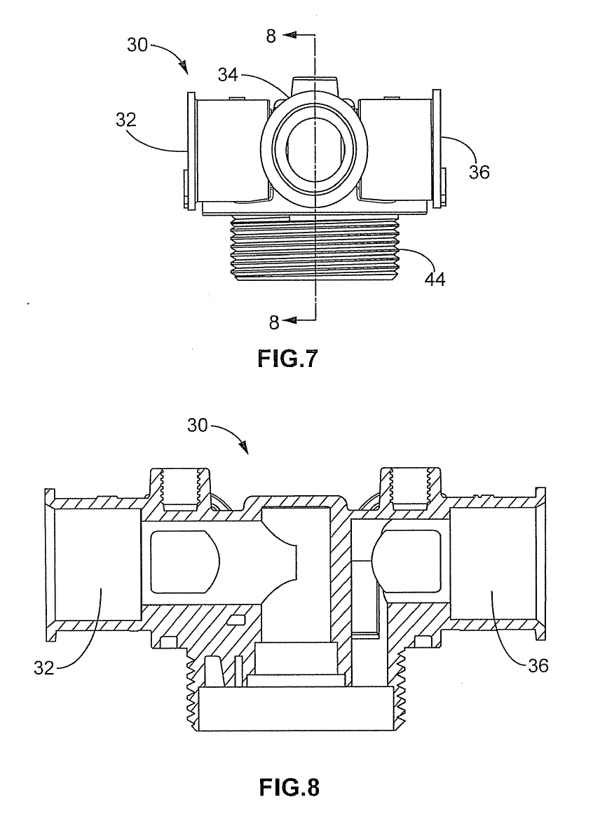

Referring now to FIG. 7, an end view of a tank head in accordance with the present invention is shown, and a cross-sectional view of the end view is shown in FIG. 8. As seen in FIGS. 7 and 8, input port 32 and output port 36 can be incorporated into a singular tank head 30 and be in fluid communication with one another via an associated fluid treatment tank.

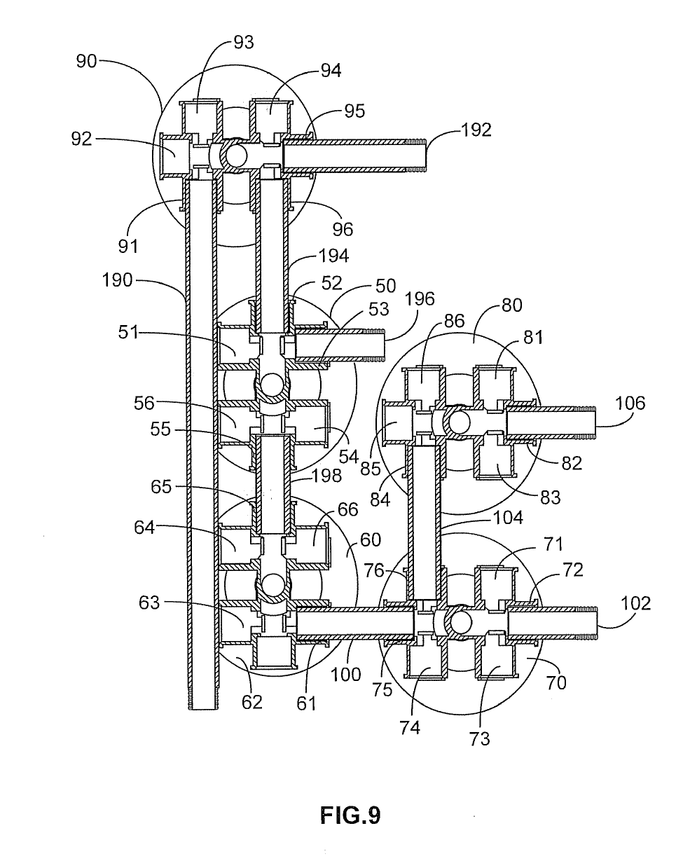

FIG. 9 is a top view of a system of tank heads incorporating multiple ports and connections therebetween in accordance with the present invention. In a system of tank heads in accordance with the present invention, various ports incorporated within a tank head can be connected to one another and to fluid supply lines via connection adapters.

A connection adapter in accordance with the present invention can include two ends: a first end and a second end. A first end of the connection adapter can include an O-ring-type seal, which allows the connection adapter to be connected to a port of the tank head. A retaining clip can hold the connection adapter in communication with the port of the tank head, and the O-ring-type seal can provide for a sealing means between the connection adapter and a port of the tank head. A connection adapter can have more than one O-ring-type seal for positive sealing of the fluid.

A second end of the connection adapter can have a thread or barb. The thread or barb allows for easy connection to fluid supply lines or to a connection adapter in communication with a port of another tank head.

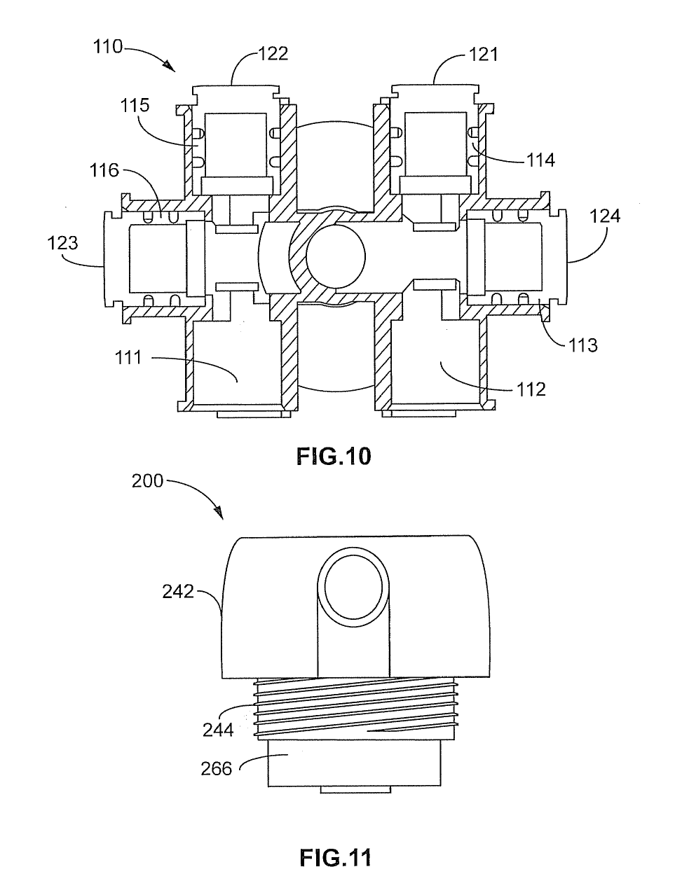

As seen in FIG. 9, a system of tank heads can include tank heads 50, 60, 70, 80 and 90. It is to be understood that the number of tank heads included in the system is not a limitation of the present invention. Rather, the number of tank heads could be more or less than the number shown in FIG. 10.

In the exemplary embodiment illustrated in FIG. 9, tank head 50 incorporates ports 51, 52, 53, 54, 55, and 56. Tank head 60 incorporates ports 61, 62, 63, 64, 65, and 66. Tank head 70 incorporates ports 71, 72, 73, 74, 75, and 76. Tank head 80 incorporates ports 81, 82, 83, 84, 85, and 86. Tank head 90 incorporates ports 91, 92, 93, 94, 95, and 96.

As can be seen in FIG. 9, port 91 of tank head 90 is connected to a fluid supply line 190. Port 95 of tank head 90 is connected to a fluid supply line 192. Port 96 of tank head 90 is connected to port 52 of tank head 50 via a fluid supply line 194. Port 53 of tank head 50 is connected to a fluid delivery line 196. Port 55 of tank head 50 is connected to port 65 of tank head 60 via a fluid supply line 198. Port 61 of tank head 60 is connected to port 75 of tank head 70 via a fluid supply line 100. Port 72 of tank head 70 is connected to a fluid delivery line 102. Port 76 of tank head 70 is connected to port 84 of tank 80 via a fluid delivery line 104. Port 82 of tank head 80 is connected to a fluid supply line 106. The various fluid supply lines and fluid delivery lines can be connected to their respective ports via the connection adapters as explained above.

It is to be understood that the connections between the various ports of the tank heads shown in FIG. 9 are not limitations of the present invention. Rather, they are only exemplary. The configuration of the connections between the various ports of tanks heads within a system and connections to fluid supply lines allow for variation in the flow pattern of the fluid.

Referring now to FIG. 10, a top view of a tank head incorporating multiple ports and plugs in accordance with the present invention is shown. As can be seen in FIG. 10, a tank head 110 can include ports 111, 112, 113, 114, 115, and 116. If a port is unused, it can be blocked off by a plug. As seen in FIG. 10, ports 113, 114, 115, and 116 are blocked with plugs 120, 121, 122, and 123, respectively. Therefore, in the exemplary embodiment of FIG. 10, fluid only flows into and out of ports 111 and 112, respectively. Plugs can be used in connection with a system of tank heads to control the flow of fluid therethrough.

FIG. 11 is a side view of a tank head in accordance with the present invention in association with a protective cover and a lower strainer basket. The protective cover 242 of the tank head 200 can be placed over the various ports associated with the tank head 200. Further, a lower strainer basket 266 can be situated below the connection fitting 244 of the tank head 200.

From the foregoing, it will be observed that numerous variations and modifications may be effected without departing from the spirit and scope of the invention. It is to be understood that no limitation with respect to the specific apparatus or method illustrated herein is intended or should be inferred. It is, of course, intended to cover by the appended claims all such modifications as fall within the scope of the claims.

What is claimed:

1. A tank head comprising:
a plurality of input ports, the plurality of input ports being in direct communication with one another;
a plurality of output ports, the plurality of output ports being in direct communication with one another; and
a connection fitting, the connection fitting being capable of associating the tank head with a with a fluid tank, wherein the pluralities of input and output ports are in fluid communication with one another, and ends of each one of the input ports and output ports in the pluralities are capable of being associated with a first end of a connection adapter.

2. The tank head of claim 1 wherein the tank head is formed of a material that is inert and non-reactive to a fluid flowing through the tank head.

3. The tank head of claim 2 wherein the material is one of plastic, chrome, stainless steel, or brass.

4. The tank head of claim 1 wherein the first end of the connection adapter comprises at least one O-ring seal.

5. The tank head of claim 1 wherein a second end of the connection adapter is threaded or barbed.

6. The tank head of claim 1 wherein at least one in the plurality of input ports or one in the plurality of output ports is capable of receiving a plug.

7. The tank head of claim 1 wherein the plurality of input ports and the plurality of output ports are connected to one another via at least one port connection.

8. The tank head of claim 7 wherein the at least one port connection is one of a straight pipe, and elbow, a tee, a barb, or a reducer.

9. A system of tank heads comprising:
a plurality of tank heads;
a plurality of connection adapters; and
a plurality of fluid supply or delivery lines;
wherein each tank head in the plurality of tank heads comprises:
a plurality of input ports, the plurality of input ports being in direct communication with one another;
a plurality of output ports, the plurality of output ports being in direct communication with one another; and
a connection fitting, the connection fitting being capable of associating the tank head with a fluid tank;
wherein ends of each one of the input ports and output ports within the pluralities of input and output ports are capable of being associated with first ends of connection adapters within the plurality of connection adapters; and
wherein second ends of connection adapters within the plurality of connection adapters are capable of being connected to first ends of fluid supply or delivery lines within the plurality of fluid supply lines.

10. The system of tank heads of claim 9 wherein each tank in the plurality of tank heads is formed of a material that is inert and non-reactive to a fluid flowing through the tank head.

11. The system of tank heads of claim 10 wherein the material is one of plastic, chrome, stainless steel, or brass.

12. The system of tank heads of claim 9 wherein the first end of the connection adapter comprises at least one O-ring seal.

13. The system of tank heads of claim 9 wherein the second end of the connection adapter is threaded or barbed.

14. The system of tank heads of claim 9 wherein at least one in the plurality of input ports or in the plurality of output ports is capable of receiving a plug.

15. The system of tank heads of claim 9 wherein the plurality of input ports and the plurality of output ports are connected to one another via at least one port connection.

16. The system of tank heads of claim 15 wherein the at least one port connection is one of a straight pipe, and elbow, a tee, a barb, or a reducer.
